(19) United States
(12) Patent Application Publication
(10) Pub. No.: US 2016/0319652 A1
(43) Pub. Date: Nov. 3, 2016

(54) HYDROSTATIC STORAGE OF PRODUCED WATER

(71) Applicant: Chevron U.S.A. Inc., San Ramon, CA (US)

(72) Inventors: Christopher John Kalli, Herne Hill (AU); Russell Evan Cooper, Martinez, CA (US)

(21) Appl. No.: 15/141,924

(22) Filed: Apr. 29, 2016

Related U.S. Application Data
(60) Provisional application No. 62/156,717, filed on May 4, 2015.
(60) Provisional application No. 62/156,104, filed on May 1, 2015.

(51) Int. Cl. E21B 43/36; C02F 1/02; C02F 1/00; C02F 1/40

(52) U.S. Cl. CPC E21B 43/36; C02F 1/40; C02F 1/02; C02F 1/004; C02F 2001/007; C02F 2101/32

(57) ABSTRACT

A subsea storage unit (SSU) with a flexible bag (flexible bladder or expandable skin) is used for produced water storage. The use of the SSU allows the solids to settle out in the storage vessel that would otherwise have settled out and accumulated on underwater surfaces, removal of hydrocarbons and the smoothing out of variations in water quality resulting from process upsets. Solids that remain in suspension and exit the SSU will then disperse without any appreciable settlement to be completely dispersed. Accumulated solids can be retrieved with the expandable skin, which can then be replaced for continued service.

### CROSS-REFERENCE TO RELATED APPLICATIONS

This application claims priority to U.S. Provisional Patent Applications entitled “Hydrostatic Storage of Produced Water” filed May 1, 2015 and May 4, 2015 assigned U.S. application Ser. No. 62/156,104 and U.S. application Ser. No. 62/156,717, respectively.

### BACKGROUND

Offshore processing of production fluids from subterranean hydrocarbon reservoirs located beneath large bodies of water, such as the sea or lakes, is necessary for the transport of hydrocarbons from the vicinity of the producing field to the point of use or to the next processing and, or transport node. Offshore processing includes removing the water and solid phases in the produced hydrocarbons. There are customer specifications necessitating the removal of water. Additionally, water if present over certain amount, may accelerate pipeline corrosion and blockage of the transport pipeline due to the formation of ice-like structures or “hydrates.” Hydrates can form at temperatures and pressures experienced when transporting production fluids in pipelines beneath large bodies of water. Additionally, solids present in the produced water may cause erosion to the transport systems and build up in tanks and pipelines promoting corrosion.

Presently, the water and solids separated and removed offshore can be disposed of either by discharge near the surface of the body of water, or injected into a selected subterranean reservoir. The solids may be transported to a remote (e.g. onshore) facility for disposal. In both cases, the water and solids are treated to ensure the required technical and regulatory quality requirements are met prior to disposal. The cost of designing, constructing and operating surface based offshore processing facilities can be a significant component in the economics of field development, with processes including filtration, floating, chemical conversion, and absorption. The high costs are largely driven by the surface facilities capital costs of offshore supporting structures and risers, and by the operating costs for manned facilities offshore. Risers are pipelines that transfer the fluids from the bottom, e.g. seabed, to the processing facility located on the surface and back to the bottom, as in the case of export pipelines taking fluids to shore or to a tanker loading facility.

Once the produced water has been separated from the produced well fluids, in order to meet the necessary residual hydrocarbon and solids specifications, additional produced water processing may be required. The disposition of the separated water and solids can be any of: transport along a dedicated pipeline to a host facility for further treatment and disposal; injection into a selected subterranean reservoir; or discharge of clarified produced water direct to the body of water adjacent to the processing facility. Subsurface injection is very expensive, involving the cost of a well or wells, as well as additional power and subsurface facilities.

To overcome the cost challenge of offshore surface based processing, some or all of the processing may be carried out on the floor of bodies of water such as the seabed or lake bottom. However, the depth and capacity of processing equipment located below the water surface is limited by the external static pressure which increases the cost needed to provide the external mechanical strength required. The increased cost is due to the greater thickness of metal needed to provide this strength.

There is still a need for improved methods and systems to contain and treat contain produced water to meet water disposition specification requirements, particularly underwater systems requiring a large capacity, e.g., a depths over 10 meters.

### SUMMARY OF THE INVENTION

In one aspect, the invention relates to a method to remove contaminants such as oil and solids from produced water. The method comprises: providing a supply of produced water, wherein the supply of the produced water is located off-shore supplied from either a surface situated or a below-surface situated processing facility; providing a large subsea fluid container system with a filled capacity of at least 5,000 m³ or as determined by the required throughput of produced water, nature of contaminants including solids and required discharge clarified water quality, wherein the container system comprises at least a flexible bladder for containing the produced water, wherein the flexible bladder is protected by a rigid external structure that permits inflow and outflow of surrounding water to equalize pressure on either side of the flexible bladder irrespective of volume of produced water contained therein and by so doing overcoming the limitations of depth and capacity, the flexible bladder having at least an inlet and at least an outlet with the inlet and the outlet being connected to outside the external rigid structure; filling the flexible bladder to its maximum working volume with the produced water through at least a produced water inlet pipe having the associated outlet extending into the flexible bladder, wherein the produced water is introduced into the flexible bladder at a sufficient rate to allow the solids to settle at the bottom of the flexible bladder through density difference with the produced water under the influence of gravity, and the hydrocarbons to rise to the top of the bladder through density difference with the produced water under the influence of gravity, forming a multi-phase system of at least three phases, a solid phase at the bottom of the bladder, an intermediate phase containing clarified water, and a top phase or phases containing hydrocarbons;

removing the hydrocarbons from the flexible bladder through one or more hydrocarbon return outlet pipes having the associated inlet terminating in the top phase or phases containing hydrocarbons; removing the clarified water from the flexible bladder through a clarified water outlet pipe having the associated inlet terminating in the intermediate phase containing the clarified water; terminating the produced water inlet pipe at a different point in the bladder to that of the inlet of the clarified water pipe and providing at least an inlet pipe distribution device and at least a clarified water inlet pipe device and configuration as a means of directing the produced water and contaminants flow paths inside the bladder to promote the clarification of the produced water; and discharging the clarified water into a water column external to the containment system.

In another aspect, the method further comprises removing the flexible bladder and replacing with a new one for continued service.

### BRIEF DESCRIPTION OF THE DRAWINGS

The present invention and its advantages will be better understood by referring to the following detailed description and the attached drawings in which.

FIG. 1 is a schematic diagram showing a flexible subsea storage unit (SSU) for use as buffer tank for produced water from topside.

FIG. 2 is a diagram showing a flexible SSU for the separation of oil droplets and solids from a subsea process.

FIG. 3 is a diagram showing a control, valve and instrumentation scheme for a flexible SSU to store produced water from topside.

FIG. 4 is a diagram showing a control, valve and instrumentation scheme for a flexible SSU to store produced water from a subsea process.

FIG. 5 is a diagram showing a horizontal SSU design.

### DETAILED DESCRIPTION

Underwater hydrostatic storage systems have been developed for the storage of produced oil and oil production chemicals. In one example, a large storage capacity located on the underwater surface comprises an expandable and collapsible skin (“flexible bladder”) within a protective shell. The protective shell renders the system robust to the effects of large external pressures, allowing deployment at almost any water depth without the usual constraints on size or capacity.

In one embodiment, the system comprises at least a flexible bladder within a protection shell for the storage of produced water, providing a quiescent volume between the former water discharge point and the general environment. A sufficient residence time is provided to allow the solids to settle out in the storage vessel (that would otherwise have settled out and accumulated on underwater surfaces). Accumulated solids can be retrieved with the expandable skin, which can then be replaced for continued service.

The system provides for storage and removal of oil, gas, and solid contaminants in the produced water with minimal disruption to upstream production operations. Further in one embodiment, the discharged water meets environmental requirements for hydrocarbon content, which is generally taken to be on average to be less than 30 mg/litre, with a peak or short term content of 40 mg/l. These requirements will vary according to regulatory regimes and operational standards. Some regulations also specify levels or limits for solids discharged with the produced water, limiting undesirable compounds or elements in the sediments at the bottom of the body of water. In one embodiment, solid particles entering the system settle out inside the subsea container, and wherein the remaining solids that leave the subsea container have a higher tendency to remain in the water column sufficiently low in concentration, meeting dilution criteria and removing particulates from produced water discharged to mitigate harmful accumulations of toxic materials including heavy metals in sea bed sediments. In the inventive storage system, the behavior of the solids (e.g., contaminants) inside the flexible container is subject to the physical laws pertaining to the movement of small particles in a continuous body of liquid, where the densities of the particles do not equal that of the liquid. The influence of these physical laws on the movement of small particles in a continuous body of liquid can be modelled using CFD (Computational Fluid Dynamics) using the characteristics of the system. In one embodiment, the characteristics for CFD modelling include a flexible container for storage, the produced water to be stored, oil droplets, gas bubbles and solid particles. The CFD models can be used to model internal flow patterns and separation efficiency in one embodiment, and determine the size and optimal flow regime in the storage container in another embodiment. The models are also used to determine the positioning of the produced water inlet pipe termination point, inlet to the clarified water pipe, as well as the design of flow distribution devices and pipeline inlet or outlet configurations.

Subsea Storage Unit (“SSU”):

The system in one embodiment comprises a flexible bladder for use as the subsea storage unit for the produced water. The flexible bladder is a collapsible inner liner used inside a protection structure, which acts as a second barrier between the seawater and produced and allow for settling of solid particles. The use of the flexible SSU with large volume and high residence time allows separation of smaller solid particles and oil droplets in the 10-100 μm range, without the use of additional internals like e.g. coalescers, wire mesh or centrifuges.

In one embodiment the seawater outlet is provided with at least two replaceable filters of 100% water effluent capacity designed to prevent passage particles with sizes of 50, 10, 5, or 1 micron size. The filter size is set to meet effluent particle specifications as required to meet environmental objectives, which may include prevention of solids accumulation in marine sediments near the effluent. The provision of spare filter capacity helps increase reliability in the case that one of the filters becomes plugged.

Flexible Bag (Bladder):

In one embodiment, the flexible bag (bladder) is attached to a removable hatch which allows for the bag to be removed and replaced. When used for the storage of produced water, the flexible SSU allows the floatation of hydrocarbons and settling of solid particles.

In one embodiment, the bag material consists of a fabric/weaving as the main structure providing the required mechanical properties and strength. In another embodiment, the bag is further coated with an elastomeric coating on outside/inside to protect the weaving, give it the necessary resistance to chemical degradation and make it liquid proof. The coating on each Depending of the use and purpose the weaving and coating can be selected from numerous material alternatives. The coated fabric is delivered in sheets on rolls, and because of the size, the rolls are joined together in order to form a construction. Joining methods used are vulcanization. The joining quality and strength is designed to be at the same level as the base material to form a consistent construction. In one embodiment, vulcanized rubber type of materials (elastomer—cross linked polymer) are used to withstand aging caused by oil contaminated water, pressure and temperature.

The flexible bag with content of up to 50 tonnes (dry weight), can be retrieved to the surface and transported to a treatment facility on a regular basis, leaving no solid particles in the sea. A standard IMR (Inspection, Maintenance and Repair) vessel can be used to perform bag replacement.

Flexible Bag—Pipe Interface:

The flexible material of the bag is attached to a hatch or another rigid construction (e.g. inlet outlet pipes). In one embodiment, a reinforced rubber flange is used. The elasticity in the bag material distributes forces over a larger area and high forces are avoided. The bag and interface can be designed with the necessary strength to be able to lift and remove the bag with a defined load, e.g., the weight of the accumulated solid particles that will settle in the flexible bag may be up to 50 tonnes in air.

Protective Shell:

In one embodiment, the protective shell has capacity ranging from 5,000 m3 to 25,000 m3, with a top opening to allow for flexible bag removal.

The protective shell can be fabricated out of steel, concrete, or glass-reinforced plastic (GRP). The inner panel of the structure can be made from metal plates formed into a cylinder/dome assembly. The inner shell is strengthened with horizontal (ring) and vertical T-beam stiffeners around the circumference to avoid buckling. If foundation design shows a requirement for anchoring with e.g. piles, the structure may be equipped with pile sleeves.

The inner surface of the main structure is smooth to reduce wear and potential damaging effects to the liner bag material. Corners and edges on the inner surface are designed to have as large radii as possible, for a transition between floor and cylinder wall without any sharp edges.

The protective shell is provided with seawater inlets/outlets around the circumference, allowing for flooding of the structure during installation and to ensure sufficient capacity of water inlet/outlet during liner bag filling and emptying. In one embodiment, the water inlets are designed with filter/grid to avoid fish, sand or other particles to enter the tank. The filter/grid may be replaceable with remote operated vehicles (ROV), for example in case of marine growth. Additionally, the opening in SSU top dome may be designed with ROV removable GRP panels, for insulation purpose or for protection of liner bag.

An example of a design for the SSU protective shell follows: Internal diameter of SSU protective shell main structure 25 m; Outer diameter of SSU main structure 27 m; Total height of SSU main structure: (bottom SSU to top of hatch, no valves included): 25 m; Estimated dry weight main structure including: Hatch frame/assembly and liner bag of 466.5 t (Shallow water conceptual design); or 438.5 t (Deep water conceptual design).

Design of Hatch Frame Integrated with the Hatch Assembly.

In one embodiment, the SSU is designed with a hatch frame which can be removed/reinstalled simultaneously with the hatch or separately. The hatch frame can be designed as a separate assembly to allow for reuse when the hatch assembly is shifted on vessel deck. In one embodiment, the hatch frame contains buoyancy elements to make them “fold-up” in submerged state.

Installation of Flexible Bag:

In one embodiment, the flexible bag of the SSU unit should last at least 10 years. However, as sediments are expected from the produced water, a more frequent replacement may be required. The hatch assembly and bag are delivered in one unit for the crude oil SSU design. In this mode the liner bag is packed around the center pipe, forming a stiff cylinder. The baseline installation method is to have the hatch and liner bag unit horizontally located on vessel deck, placed on temporary supports. The assembly is then horizontally hoisted over the vessel side and through splash zone. By using this configuration, the required lift height is reduced and the assembly will be significantly more stable than with a vertical lift. In submerged state, the unit is upended and the sling arrangement reconfigured for vertical installation. To reduce the landing forces and enable controlled engagement of the hatch into the SSU, the hatch assembly may include a soft landing system.

The inner surface of the protection structure and floor should be smooth to reduce friction and to avoid any wear when the bag is in contact with those surfaces. Sea growth on the surfaces will be limited as the bag will be in contact with the surface all the time except for the short time for replacement. The risk of any severe wear is considered low as the movement of the bag will be very limited as it will stay permanently open and is not expected to be dragged very much along the surface.

Foundation for Storage Tank: The protective shell (and flexible bladder contained within) can be anchored to the seabed by a number of foundation options including: a pile foundation; a suction caissons; a gravity based structure with skirts; or a rock foundation. Selection of the appropriate foundation depends on a number of factors, including: installation site location (e.g., water depth, seabed properties and weather data); availability of installation vessels and materials in the region; schedule impact; and subsea infrastructure (e.g., mooring pattern if present, area limitations on seabed, location of manifold and length of connecting spools, numbers of SSUs, etc.).

Design & Operations:

In one embodiment, the central part of the SSU consists of a pipe-in-pipe that runs centrally from the top hatch to the bottom of the SSU. The pipe-in-pipe consists of an outer large diameter pipe (diameter >1 m), that encompasses the inlet and outlet pipes entering through the top of the hatch. The pipe also provides a physical barrier between the inner pipes and the SSU bag when emptying the bag. The bag will then wrap around the outer pipe column.

SSU for Storage of Produced Water from Topside:

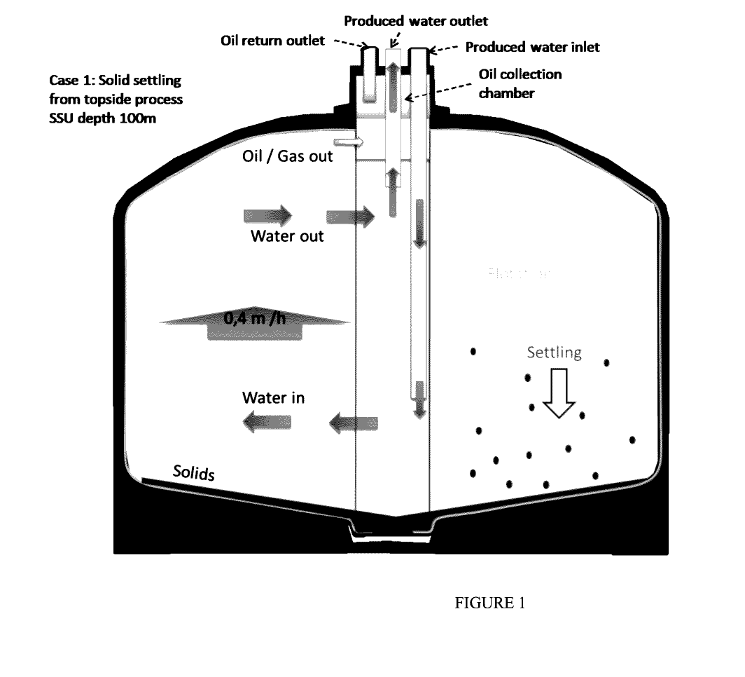

In one embodiment, the produced water is received through the inlet pipe at the top of the hatch and extends to the lower compartment of the pipe-in-pipe. The outlet of the pipe-in-pipe is positioned close to the bottom of the pipe-in-pipe, so that water flows through perforations in the lower part of the outer pipe to the main volume in the flexible bag as shown in FIG. 1.

The pipe-in-pipe is divided into an upper and lower compartment. This is to allow the hot incoming water to more effectively transfer heat to the oil layer that is collected in a chamber at the top of the pipe-in-pipe. The purpose of heating the oil is to prevent any possible hydrate formation. A predominantly upward flow is established in the main hold-up. The water leaves the bag through perforations in the outer pipe to the upper pipe-in-pipe compartment and through the outlet piping to the top hatch. The outlet pipe runs to the SSU base level, and the water is discharged to directly to sea.

The oil droplets with sufficiently large rise velocity float to the top of the bag, and through perforations at the top of the outer pipe. In one embodiment, the perforations at the top of the outer pipe are placed higher than the perforations for the incoming produced water to avoid turbulence at the inlet pipe exit which may shake up the oil-water interface. The oil is collected in a chamber at the top of the pipe-in-pipe. From this chamber, the oil (and possible gas) is returned to the process through a separate outlet pipe. In one embodiment, a pump is used for this purpose. Control of the oil-water interface can be achieved by pump on/off control, or a dedicated on/off control valve in combination with a pump.

Solid particles contained in the water will settle at the bottom of the bag. The solid deposit can be contained in the bag until sufficiently large amounts have deposited. The solids will then be removed for disposal, by retrieving the complete bag and pipe-in-pipe arrangement, replacing it with a new bag. In one embodiment, replacement can be done at 1-2 year intervals. During this operation, the SSU may not be operational. If it is necessary to maintain production, two parallel SSU's could be installed, to allow switching to another unit when bag needs to be replaced.

The placement of the water inlet and outlet perforations is designed to establish the best possible flow pattern internally in the bag. For a gravity settler or flotation tank, either a horizontal tank with settling occurring perpendicular to main flow direction or vertical tanks with predominantly radial or upwards flow are used. For the vertical type, water outlets will typically be peripheral, which allows an even flow distribution in the separation zone. In one embodiment, the SSU has both the outlet and inlet placed centrally, which may not allow for optimal flow patterns for settling and flotation of particles and droplets. Internal circulation flows may arise which may “short circuit” the separation locally. Detailed CFD calculations of the internal flow patterns and separation efficiency can be carried out to optimize the placement of the inlet and outlet pipes, as well as the perforation placements and other flow conditioning devices, e.g., baffles and flow distribution devices that can be accommodated within the limitations of the vertical storage system.

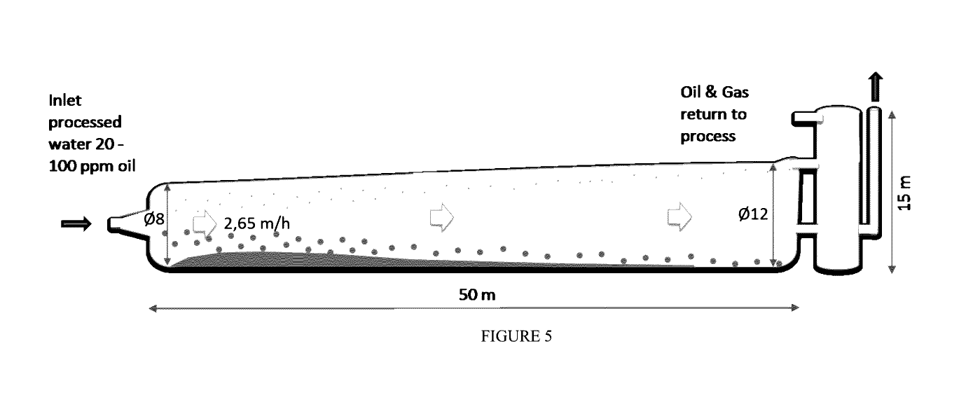

In one embodiment, the SSU is of a horizontal design as illustrated in FIG. 5. With a horizontal separator, a high L/D ratio can be achieved for establishing a streamlined and laminar flow. Separation of particles and oil droplets is more readily achieved with settling perpendicular to the horizontal bulk flow direction.

Generally, the pressure in the process from which the produced water is received will be different from the hydrostatic pressure in the SSU. In case 1, the hydrostatic pressure is 10.1 barg at 100 m depth. In one embodiment, the produced water is received from a 3rd stage separator or an oil/water coalescer, typically operating at lower pressures (1-5 barg). A booster pump is provided to pump the produced water from topside to the SSU. Likewise, the collected oil is pumped back to the process. The static head from topside to the SSU should ensure that oil droplets stay in liquid phase. In one embodiment with a residence time in the bag of at least 50 hours, the SSU has the capability of significant smoothening oil content variations to maintain effluent concentration below 30 ppm oil.

Produced Water from Subsea Process.

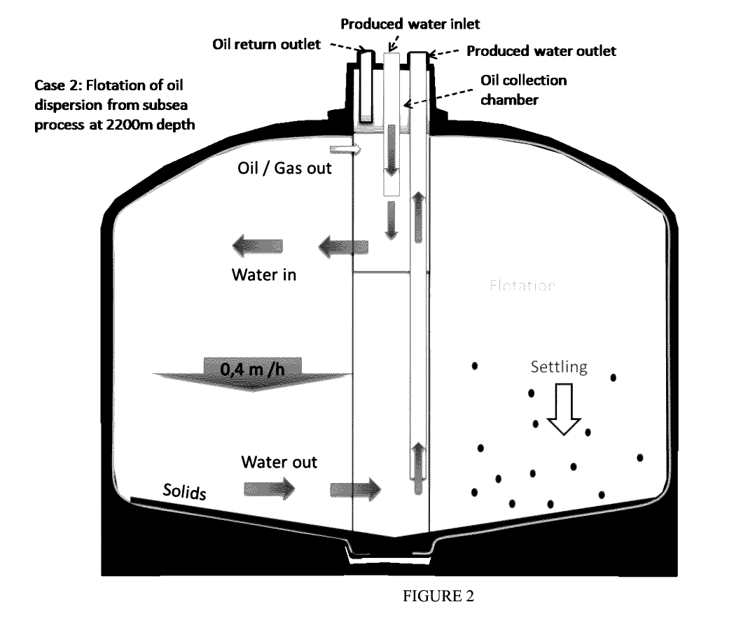

In one embodiment for the storage and treatment of produced water from a subsea process, the position of the inlet and outlet is different for the treatment of produced water from topside. In one embodiment to separate residual oil dispersed in water, the outlet of the water inlet pipe and the perforations for flow to the main body are positioned close to the top of the pipe-in-pipe as illustrated in FIG. 2. The entrance of the outlet pipe and the perforations for flow from the main body, as shown, are placed close to the bottom to provide predominantly downward water flow, counter-current to flotation of oil droplets.

As illustrated, the water inlets and outlets are placed with sufficient clearance to the solid sediments at the bottom, to not create turbulence that stir up particles. Further, clearance from the upper outlet/inlet to the oil/water interface is provided. In one example at 2200 m seabed depth, the hydrostatic pressure in the SSU is 221.2 barg. The pressure in the upstream subsea separators may both be higher or lower than the hydrostatic pressure. The produced water feed is therefore likely to be routed via a separator level control valve or a pump to the SSU. The oil droplet dispersion could further break up towards smaller droplets across this valve or pump. The oil that is collected at the top of the bag is sent back to the process either by pumping or through a valve (depending on pressure). Since the net oil rate is small, a moderate sized pump or small valve can be used. The pump (or valve) is on/off-controlled between two specified interface level limits.

In one embodiment with a lower hydrostatic pressure in the SSU than the subsea process, gas bubbles are likely to be released from the oil droplets. A gas pocket will therefore be formed above the oil phase. In this case, the outlet pump is designed to handle two-phase flow to return both oil and gas to the process, with a gas/oil mixing arrangement upstream of the pump suction.

Performance:

In one embodiment with a hold-up volume of >5,000 m³ in one embodiment and at least 10,000 m³ in a second embodiment, any variations in incoming oil content due to possible process upsets can be smoothened in the SSU outlet stream. The system with the flexible storage can be used for removal of oil droplets from a deep water subsea process from 100 ppm down to regulatory 30 ppm by flotation, as well as the separation of solids.

In one embodiment, the SSU is for the removal of target droplet sizes 24-150 μm with a tank having a height to diameter ratio of 0.8 (e.g., for D=25 m, H=20 m). The SSU can be sized for optimal height taking into consideration needed volumes and clearances of oil blanket and solid sediments, as well as the height needed to establish the desired flow field. In one embodiment for a superficial downward velocity for a production of 30 000 bbl/day is 0.405 m/h for a tank internal diameter of 25 m. Droplets with a rise velocity higher than this will float to the top of the tank, and oil droplets of size 33 μm will be completely removed. Smaller droplets will be partially removed, at a ratio proportional to their rise velocity.

In another embodiment for a SSU design size is 25 000 m³, the tank has an inner diameter of 35 m and height of 39 m. For this maximum size, oil droplets down to 23 μm may be separated by gravity. In one embodiment of the SSU as a vertical gravitational settling tank with both water inlet and outlet in the centre of the tank, ideal flow patterns may not be achieved. The settling of solid particles in the tank is given by Stokes equation as for oil droplets. For this design, it is anticipated that the total amount of solid particles is 95.4 kg/day. The settling velocity for a particle size of 15.3 μm is designed to be 0.403 m/h is also given, which is just below than the superficial velocity 0.405 m/h. It is expected that particles with diameter large than 100 μm will settle completely. Most of the particles between 10 μm and 100 μm will also separate completely. A smaller fraction of particles with diameter less than 10 μm will settle—not only because settling velocity is lower than superficial velocity, but also due to influence of Brownian motions for the particles with diameter closer to 1 μm.

In addition, the net downward water flow for the base case design will cause a flow pattern in the lower parts of the SSU that is likely to be sub-optimal for settling. In sum, for the weight distribution given in the design basis, it is expected that somewhat more than 50% of the solids is separated, equaling about 50 kg/day.

In one embodiment of the SSU is located at 100 m depth close to topside processing facilities. The hydrocarbon content is expected to be reduced to an average below the 30 ppm required for discharge to sea. The function of the SSU in this case is to separate solid particles, for subsequent removal and disposal away from the facilities. For more efficient removal of solids, the net bulk water flow can be upwards to achieve close to counter-current flow. It is expected that some more than 50% of the solids as defined by the design basis distribution will be removed.

Removal of Particle Sediments.

The solids sedimentation on the bag bottom can be disposed by removing the bag with solid contents from the SSU and lifting it to surface vessel. In one embodiment with a design of 10,000 m³ capacity, if all particles are separated, 95 kg of solids per day is deposited at the bottom of the bag. The upper weight limit for removing the bag including solid contents is 50 tonnes, so the bag would need removal after about 500 days of service.

Control Architecture:

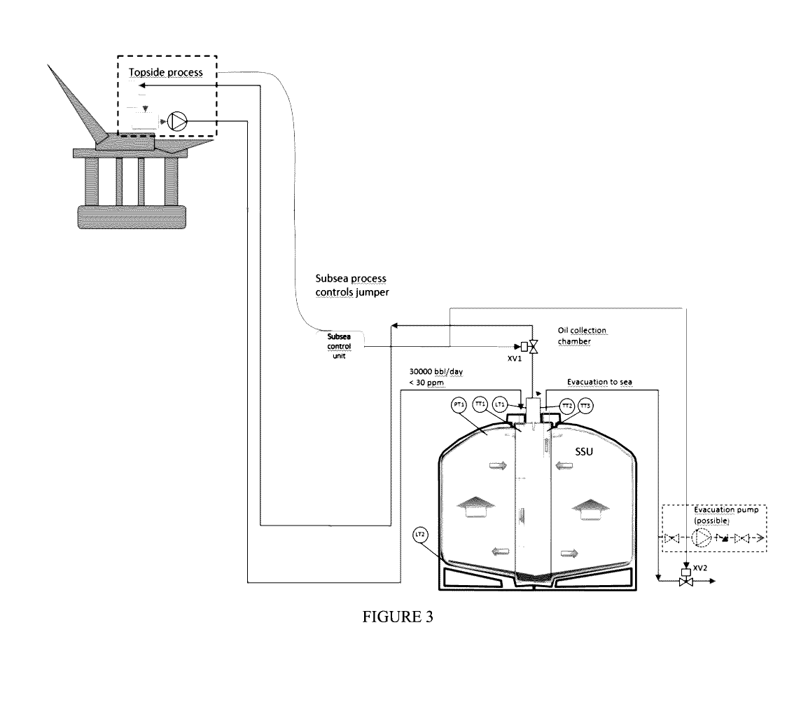

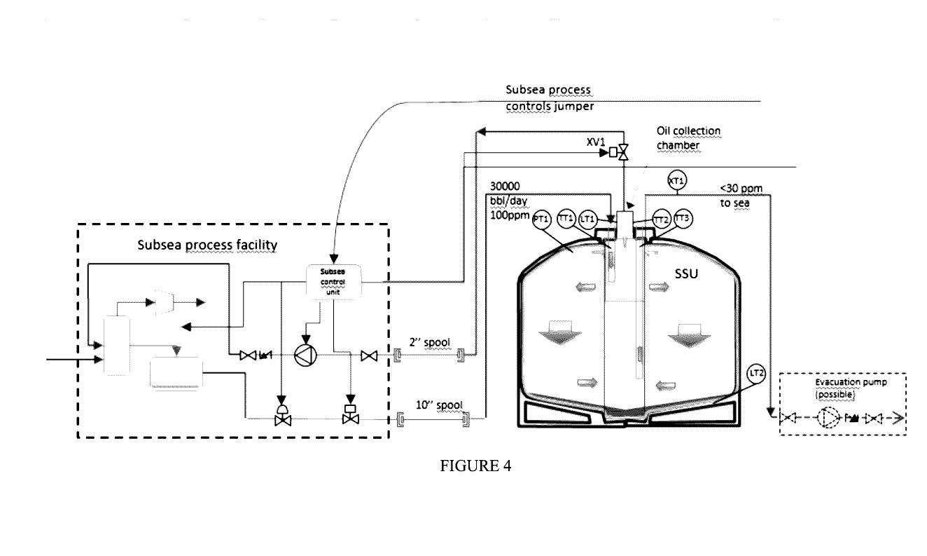

The SSU is provided with control architecture, umbilicals and instrumentation as shown in FIGS. 3 and 4. The umbilical will contain hydraulic hoses and electric cables for valve actuators and for sensors. It may also be an option to connect to any possible existing subsea umbilical riser base. A second dedicated power and controls umbilical is proposed for the subsea oil return pump. With a SSU for handling produced water from a subsea process, subsea process umbilical spare capacity can be used, in addition to the use of existing subsea control module and power supply for the subsea process as shown in FIG. 4.

Valve Configuration:

Examples of valve configurations are shown in the figures. In one embodiment, the oil collected at the top of the SSU is returned to the topside process through remote operated valve. The purpose of the valve is to isolate the tank on identification of abnormal operational conditions or oil leakage to sea. In one embodiment with produced water from top side, a remote operated isolation valve is placed on the produced water evacuation line. The purpose of the valve is to close when sufficient oil has collected at the top of the bag and needs to be removed. The oil will then be displaced through oil return line the by the pressure from the feed water. When the oil has been evacuated, the valve is opened again. For an embodiment with produced water from a subsea process, it is assumed that this valve is not needed, as the oil will have to be pumped back to the process.

Instrumentation:

In one embodiment, the SSU further includes sensors to detect the following: 1. Oil level in the hatch (internal leakage detection); 2. Oil level in the oil collection chamber; 3. Temperature in oil collection chamber; 4. Produced water inlet and outlet temperature; 5. Solid deposition level; 6. Oil content in effluent; and 7. Pressure in the bag.

Oil Level in the Hatch Annulus (Internal Leakage Detection):

The SSU is designed so that oil escaping from the bag will collect in the hatch annulus. The level of oil in the annulus represents integration over time of the leakage rate. In one embodiment for oil level monitoring in the hatch annulus, a differential pressure sensor (dP-cell) is used.

Oil Level in the Oil Collection Chamber:

The SSU is designed for oil level monitoring in the oil collection chamber at the top of the SSU with a differential pressure sensor

Oil Hold-Up Temperature:

In one embodiment, sensor on top of the SSU hatch is used to measure the oil temperature in the oil collection chamber. The oil temperature is monitored to be above hydrate formation temperature. The hatch is insulated, and temperature measurements can be measured in the steel, in order to simplify arrangement and maintenance.

Water Loading/Offloading Temperature:

In one embodiment, a temperature sensor is also mounted on the SSU hatch inlet pipe and outlet pipe, to enable monitoring and control of hydrate conditions. The temperature is measured on the pipe steel, which also could be insulated.

Solid Sediments Level:

In one embodiment, the SSU is equipped with sensors to allow for an estimation of the total weight of solids in the bag, which determines, when the bag must be replaced. In one embodiment, an acoustic sensor is used. To prevent a masking of the acoustic signal through reflection and refraction at the expected multiple boundaries between gas, oil, hydrate slush and produced water (which might even be degassing with bubbles), the acoustic sensor is mounted at the bottom of the SSU, outside the bag. In one embodiment, the acoustic sensor is a wideband echo sounder, which increases range and resolution of the system.

Oil Content in Water Effluent:

In one embodiment, a sensor system is placed on the water outlet pipe to measure the oil content of the produced water effluent, e.g., to see if the average hydrocarbon content in the water effluent is below 30 ppm. Standard fluorescence methods for the continuous on-line monitoring of oil in water are designed for topside use (e.g. falling stream flowcells based on fluorescence detection). Underwater fluorescent sensors are in general too sensitive (below 5 ppm) and affected by changes in the seawater composition (e.g. turbidity). In one embodiment, the hydrocarbon content is derived by monitoring the following parameters at the produced water outlet with an integrated sensor system: pressure; conductivity; temperature; flows; and dissolved CH4 (pCH4) in the water effluent. A fluorescent sensor can be used in addition, to complement the computed hydrocarbon content.

Pressure in Bag:

The pressure in the hold-up at top of the bag is measured in one embodiment. Since the oil level can be measured using a dP-cell, the pressure in the bag may be read from this instrument.

Water Evacuation Pump:

Prior to bag replacement, the produced water in the bag is removed. However, as the margins with respect to hydrostatic driving force will likely be small, a dedicated pump will be required for this purpose. Since evacuation of the bag will only take place with intervals of maybe a year or more, a temporarily connected pump, lowered from a surface vessel, can be used.

Hydrate Formation:

Given the hydrostatic pressure in the SSU, there is a possibility of hydrate formation on condensate droplets or any gas bubbles as they are cooled before reaching the outlet of the SSU. Even if no gas is formed in the SSU, a high mole fraction of light hydrate forming hydrocarbons (C1-C4) in the condensate may enable formation of hydrates. If hydrates should form, it will likely form a layer of ice slush between the produced water and oil interface. Some will also follow the produced water outlet to sea. As the specific gravity of hydrates is in the range 0.9-0.96, the flotation of any hydrated oil droplets may affect the separation efficiency. Hydrate in one embodiment can be prevented by any of temperature management and/or MEG injection.

Hydrate Prevention by Temperature Control:

For hydrates to form, the fluid must be cooled to below hydrate formation temperature, so keeping temperature above this threshold will therefore prevent hydrate forming. The temperature of the produced water entering the SSU will generally be high, between 40-160° C. However, due to large size and long residence time in the tank, significant cooling of the produced water can be expected. For example, at a pressure of around 221 barg for produced water from a subsea process, hydrate formation temperatures of pure components like methane and ethane are between 15-20° C., which gives an indication of the minimum allowable temperature in the SSU for avoiding hydrate formation. Below the so called “quadruple point” (gas+condensate+hydrate+free water coexist), which is approximately 35 bar, 14.5° C. for methane, the hydrate temperature curve changes slope. At this point, hydrate formation temperature decreases faster with pressure, following the equilibrium line between gas+free water and free water+hydrate most commonly reported.

At 10 barg, corresponding to depth of 100 m for an embodiment with produced water from top side, the hydrate temperature is 6° C. for propane. The oil droplets from the topside process likely have fewer amounts for light hydrocarbons. Hydrate problems are expected to be more with embodiments with produced water from a subsea process. To keep the temperature in the SSU above hydrate formation temperature, the SSU can be insulated with foam, or with heat exchange between hot inlet stream and SSU outlet stream. Since any formation of hydrates will primarily affect the oil/water interface close to the outlet stream of the SSU, the inlet stream can be used to heat the outlet stream to prevent hydrates and dissolve any hydrates already formed in the main fluid hold-up.

Hydrate Prevention by MEG Injection:

MEG injection is a common strategy for hydrate prevention in subsea process systems and pipelines. In one embodiment, the upper oil phase and a smaller part of the aqueous phase is contained in a smaller compartment at the top of the pipe-in-pipe of the SSU, allowing the necessary MEG concentrations for inhibition to be achieved (>20%). The concentration of MEG in the process can be monitored online using specialized conductivity sensors calibrated with the type of MEG used in the process.

### EXAMPLES

The following examples are given to illustrate the present invention. It should be understood, however, that the invention is not limited to the specific conditions or details described in these examples.

### Example 1

A flexible SSU is used for the storage of produced water from a facility having a max production of 30 000 barrels water per day=199 m³/h=˜5000 m³ per day. Produced water temperature can be any of ˜40° C., or <100° C. up to ˜160° C. The hydrocarbon content in one example is <30 ppm, and <100 ppm in a second case. The total suspended solid particle content is 20 mg/kg. Total suspended solids sizes include: 0.01-0.1 μm: 5%; 0.1-1 μm: 10%; 1-10 μm: 35%; 10-100 μm: 45%; 100-1000 μm: 5%. The oil density is 750 kg/m³. The solids density is 2500 kg/m³; the produced water density less than 1.074 kg/m³. The salinity Less than 100 000 ppm. The amount of scale-forming content (Calcium carbonate or others) is assumed minimal.

### Example 2

In this example, the produced water is received from topside process, to a SSU at a seabed depth of 100 m. Hydrocarbon content from topside is in average below required 30 ppm. The SSU is used to separate the solid particles for transport to treatment facility and to act as a buffer tank to smoothen out any variation in incoming hydrocarbon content before disposal directly to sea

### Example 3

In the example, produced water with a hydrocarbon content of around 100 ppm is received from a subsea process facility at a depth of 2200 m. The SSU is used to separate the solid particles for transport to treatment facility and to separate hydrocarbons to the required below 30 ppm hydrocarbon content for disposal directly to sea.

In one embodiment, for a flexible bladder with a bag volume of 10,000 m³ and a residence time of 50 h, oil droplets of 33 μm and larger will separate and float. Smaller droplets will partially float. The solid particle separation/settling is around 50 kg/day. The solids can be removed by replacing the bag when maximum limit of solids deposit in the bag has been reached. For this example, if all solid particles present in the produced water are separated at a rate of 95 kg/day, the liner bag would have to be replaced after 500 days of service.

### Example 4

A flexible SSU is designed for a residence time distribution, wherein not more than 1% of the inlet fluid is retained in the vessel for less than 50% of the mean residence time. The produced water stream has an inlet oil concentration of at least 100 ppm, 1 ppm oil is allowed for short-circuiting, thus allowing 29 ppm in the spec to be achieved by gravity settling. The vessel is designed via CFD model taking into account aspect ratios of the solids, flow rates of inlet/outlet streams, and provision of internal fluid baffles if required. The residence time is maintained to prevent unwanted emission of oil droplets or solids, by preventing short-cutting of fluid through the SSU.

For the purposes of this specification and appended claims, unless otherwise indicated, all numbers expressing quantities, percentages or proportions, and other numerical values used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention. It is noted that, as used in this specification and the appended claims, the singular forms “a,” “an,” and “the,” include plural references unless expressly and unequivocally limited to one referent.

As used herein, the term “include” and its grammatical variants are intended to be non-limiting, such that recitation of items in a list is not to the exclusion of other like items that can be substituted or added to the listed items. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs. Examples not recited herein are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A method for removing contaminants from produced water, comprising;
providing a supply of produced water, wherein the supply of the produced water is located off-shore supplied from either a surface situated or a below surface situated processing facility;
providing a subsea fluid container system with a filled capacity of at least 5,000 m³ or as determined by the required throughput of produced water, nature of contaminants including solids and required discharge clarified water quality, wherein the container system comprises at least a flexible bladder for containing the produced water, wherein the flexible to bladder is protected by a rigid external structure that permits inflow and outflow of surrounding water to equalize pressure on either side of the flexible bladder irrespective of volume of produced water contained therein and by so doing overcoming the limitations of depth and capacity, the flexible bladder having at least an inlet and at least an outlet with the inlet and the outlet being connected to outside the external rigid structure;
filling the flexible bladder to its maximum working volume with the produced water through at least a produced water inlet pipe having the associated outlet extending into the flexible bladder, wherein the produced water is introduced into the flexible bladder at a sufficient rate to allow the solids to settle at the bottom of the flexible bladder through density difference with the produced water under the influence of gravity, and the hydrocarbons to rise to the top of the bladder through density difference with the produced water under the influence of gravity, forming a multi-phase system of at least three phases, a solid phase at the bottom of the bladder, an intermediate phase containing clarified water, and a top phase or phases containing hydrocarbons;
removing the hydrocarbons from the flexible bladder through one or more hydrocarbon return outlet pipes having the associated inlet terminating in the top phase or phases containing hydrocarbons;
removing the clarified water from the flexible bladder through a clarified water outlet pipe having the associated inlet terminating in the intermediate phase containing the clarified water;
terminating the produced water inlet pipe at a different point in the bladder to that of the inlet of the clarified water pipe and providing at least an inlet pipe distribution device and at least a clarified water inlet pipe device and configuration as a means of directing the produced water and contaminants flow paths inside the bladder to promote the clarification of the produced water;
and discharging the clarified water into a water column external to the containment system.

2. The method of claim 1, further comprising:
determining quality of the clarified water removed from the flexible bladder; and optionally adjusting acceptable levels of contaminants that have accumulated inside the bladder in order to establish predetermined levels for removal;
wherein adjusting acceptable levels of contaminants comprises changing the point at which the removal process for the separated contaminants is initiated.

3. A method of claim 1, further comprising limiting the amount of contaminants inside the bladder, characterized by:
detection and on reaching a predetermined level removal of the amounts of gas contaminant risen to the top of the bladder; detection and on reaching a predetermined level removal of the amounts of oil contaminant risen to the top of the bladder;
detecting the amount of solids contaminant fallen to the bottom of the bladder and on reaching a predetermined level, extraction of the bladder from inside the rigid structure followed by placement of a new bladder into the rigid structure.

4. The method of claim 1, further comprising extracting and replacing the bladder, by hatch through which deflated bladder and associated fluid entry and exit points to withdraw the flexible bladder to outside the protective structure, wherein the hatch is designed for extraction and replacement by a standard inspection, maintenance and repair vessel.

5. The method of claim 1, further comprising preventing the formation of hydrates impeding the working of the system by providing heat associated with the production fluids, with the heat generated through an external power system.

6. The method of claim 1, further comprising adjusting the position of the inlets and outlets within the bladder to enhance removal of the oil, gas and solids contaminants.

7. The method of claim 1, further comprising conditioning the contaminants upstream of or internal to the container to enhance removal of the oil, gas and solids contaminant by any of: flocculants, demulsifiers, other chemical means, shear forces, other mechanical means.

8. The method of claim 1, further comprising filtration of the clarified water prior to discharge to the sea by filtration processes known in the art, with modular filter elements that may be isolated, removed, and replaced by a Remotely Operated Vehicle.
